(19) United States
(12) Patent Application Publication
(10) Pub. No.: US 2011/0262789 A1
(43) Pub. Date: Oct. 27, 2011

(54) BATTERY MOUNTING STRUCTURE FOR REMOTE-CONTROLLED TOY AIRPLANE

(76) Inventor: TA-SEN TU, TAICHUNG COUNTY (TW)

(21) Appl. No.: 12/767,993

(22) Filed: Apr. 27, 2010

(51) Int. Cl. H01M 2/10

(52) U.S. Cl. 429/100

(57) ABSTRACT

A battery mounting structure includes two pairs of parallel rails respectively fixedly located on two opposing body panels of a remote-controlled toy airplane in horizontal, two sliding grooves respectively defined between the parallel rails at each of the two opposing body panels of the remote-controlled toy airplane, and a battery holder detachably inserted into the sliding grooves between the two opposing body panels of the remote-controlled toy airplane for holding a battery pack.

### BACKGROUND OF THE INVENTION

1. Field of the Invention

The present invention relates to battery mounting technology and more particularly, to a battery mounting structure for remote-controlled toy airplane, which facilitates replacement and recharging of the battery pack.

2. Description of the Related Art

The battery mounting structure of a conventional remote-controlled toy airplane, as shown in FIG. 1, comprises a bottom board 11 fixedly provided between two opposing body panels 10 of the remote-controlled toy airplane, a front holder plate 12 obliquely affixed to the two opposing body panels 10 at the front side above the bottom board 11, a first battery 14 fastened to the front holder plate 12 by a fastening band 15, and a second battery 13 fastened to the two opposing body panels 10 at the rear side above the bottom board 11 by another fastening band 15. This battery mounting structure has drawbacks as follows:

1. Because the two batteries 13;14 are respectively fastened to the two opposing body panels 10 of the remote-controlled toy airplane near the top side, the center of gravity of the remote-controlled toy airplane becomes high, affecting flying stability.

2. When wishing to recharge or replace the batteries 13;14, the user must unfasten the fastening bands 15 and then remove the batteries 13;14 from the body of the remote-controlled toy airplane.

### SUMMARY OF THE INVENTION

The present invention has been accomplished under the circumstances in view. It is one object of the present invention to provide a battery mounting structure for remote-controlled toy airplane, which facilitates replacement or recharging of the battery pack when the power of the battery pack is low.

To achieve this and other objects of the present invention, a battery mounting structure comprises two pairs of parallel rails respectively fixedly located on two opposing body panels of a remote-controlled toy airplane in horizontal, two sliding grooves respectively defined between the parallel rails at each of the two opposing body panels of the remote-controlled toy airplane, and a battery holder detachably inserted into the sliding grooves between the two opposing body panels of the remote-controlled toy airplane for holding a battery pack. When the power of the battery pack is low, the battery holder can be removed from the two opposing body panels of the remote-controlled toy airplane for recharging or replacement.

### BRIEF DESCRIPTION OF THE DRAWINGS

FIG. 1 is a schematic elevational view showing a battery mounting structure for remote-controlled toy airplane according to the prior art.

FIG. 2 is an exploded view of battery mounting structure for remote-controlled toy airplane in accordance with the present invention.

FIG. 3 illustrates a battery pack fastened to the battery holder in accordance with the present invention.

FIG. 4 is an installed view of the battery mounting structure for remote-controlled toy airplane in accordance with the present invention.

FIG. 5 is a sectional front view of the battery mounting structure for remote-controlled toy airplane in accordance with the present invention.

FIG. 6 corresponds to FIG. 5, showing an alternate form of the present invention.

FIG. 7 illustrates two rails integrally formed on one body panel for remote-controlled toy airplane according to the present invention.

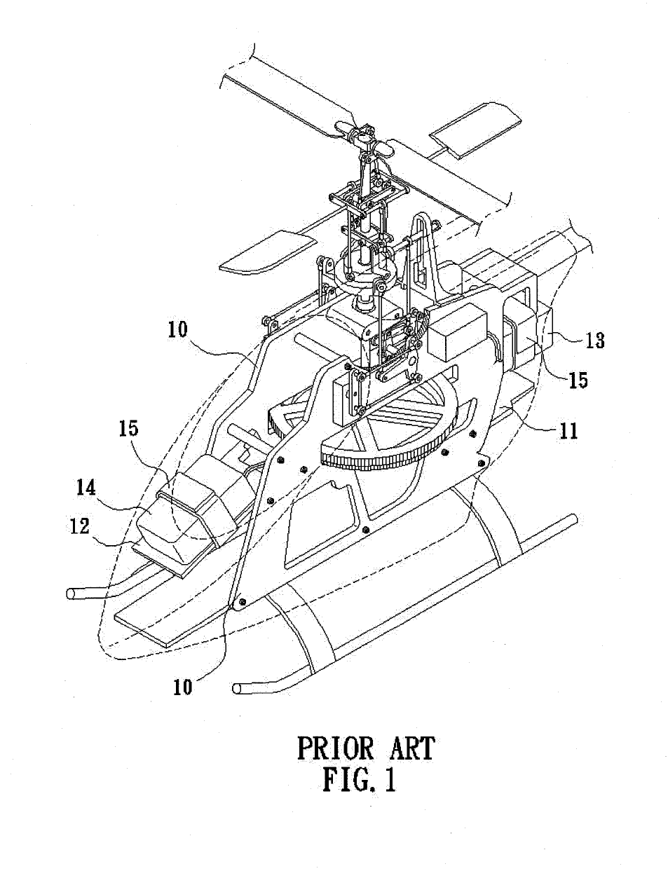

### DETAILED DESCRIPTION OF THE PREFERRED EMBODIMENT

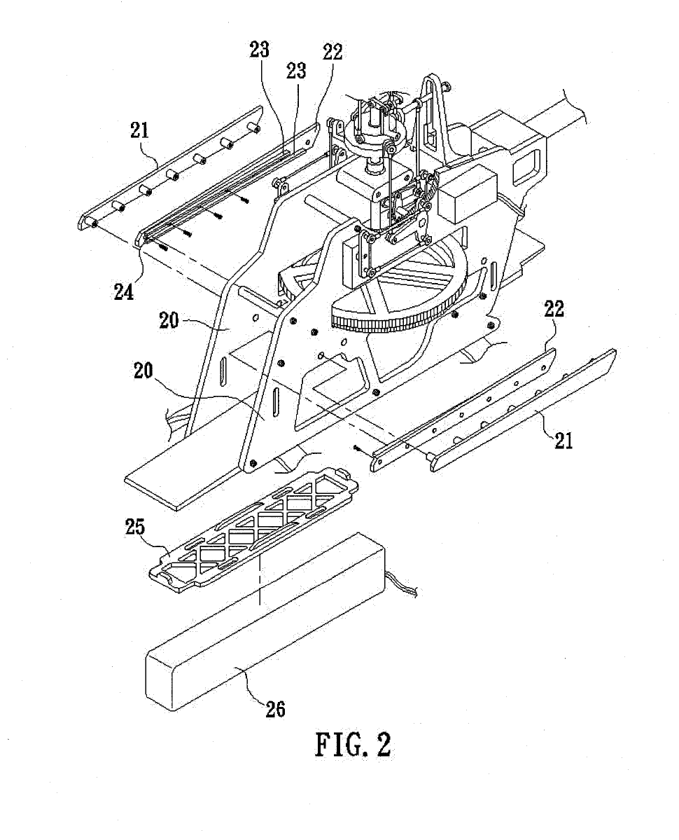

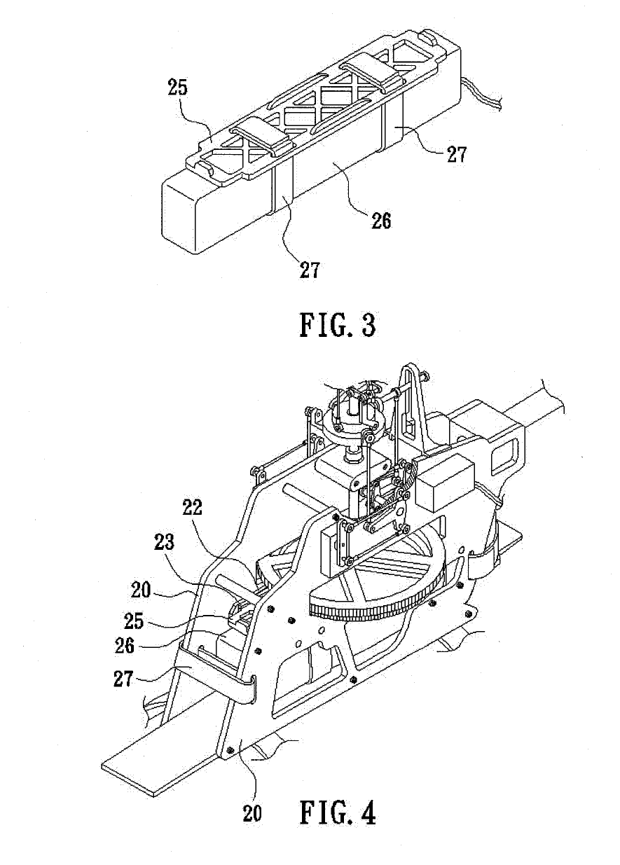

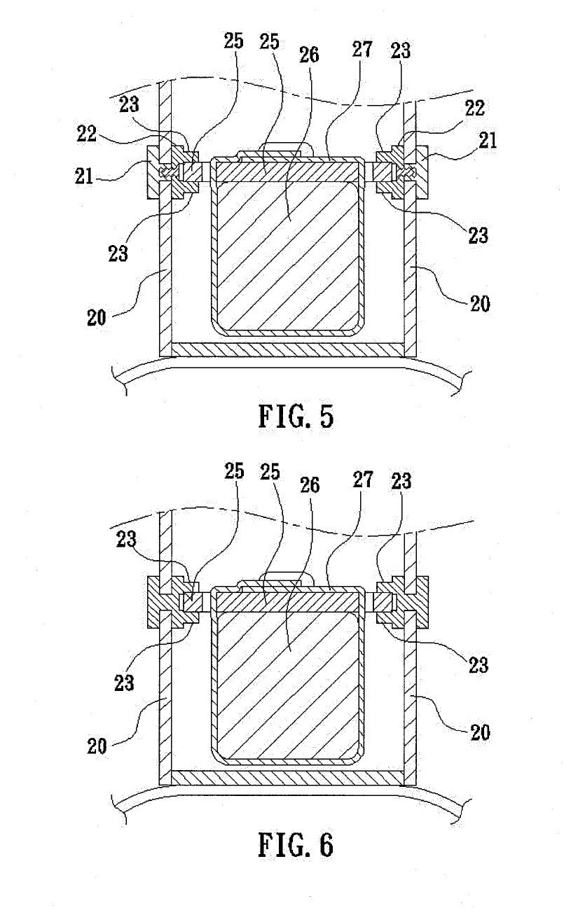

Referring to FIGS. 2-5, a battery mounting structure for remote-controlled toy airplane in accordance with the present invention is shown comprising two track boards 22 respectively and symmetrically attached to the inner wall of each of two opposing body panels 20 of a remote-controlled toy airplane, each track board 22 having two rails 23 horizontally disposed at one side thereof in a parallel manner and a sliding groove 24 defined between the two rails 23, two mounting plates 21 respectively attached to the outer wall of each of the two opposing body panels 20 of the remote-controlled toy airplane and respectively affixed with the track boards 22 to the two opposing body panels 20 of the remote-controlled toy airplane by screws, a battery holder 25 detachably inserted into the sliding groove 24 between the rail 23 at each of the two track boards 22 for carrying a battery pack 26, and fastening bands 27 adapted to secure the battery pack 26 to the battery holder 25.

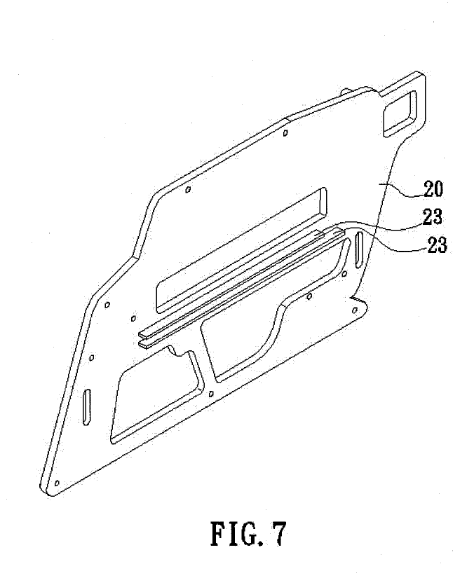

Further, the mounting plates 21 and the track board 22 with the rails 23 may be made of a different material and then molded on the opposing body panels 20 of the remote-controlled toy airplane (see FIG. 6). Alternatively, the rails 23 may be directly and integrally formed on the opposing body panels 20 of the remote-controlled toy airplane by means of injection molding (see FIG. 7).

The invention has the advantages as follows:

1. The battery holder 25 can be removed from the sliding groove 24 between the rails 23 at each of the two track boards 22, facilitating recharging or replacement of the battery pack 26 when the power of the battery pack 26 is low.

2. After installation of the battery holder 25 in the sliding groove 24 between the rails 23 at each of the two track boards 22, the battery pack 26 is disposed close to the tail boom of the rotor of the remote-controlled toy airplane so that the center of gravity of the battery pack 26 is kept in a concentric manner relative to the axis of the rotor of the remote-controlled toy airplane.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A battery mounting structure, comprising two pairs of parallel rails respectively fixedly located on two opposing body panels of a remote-controlled toy airplane in horizontal, two sliding grooves respectively defined between the parallel rails at each of said two opposing body panels of said remote-controlled toy airplane, and a battery holder detachably inserted into said sliding grooves between said two opposing body panels of said remote-controlled toy airplane for holding a battery pack.

2. The battery mounting structure as claimed in claim 1, further comprising two track boards respectively affixed to said two opposing body panels of said remote-controlled toy airplane, each said track board carrying one of said two pairs of parallel rails.

3. The battery mounting structure as claimed in claim 1, further comprising two mounting plates respectively affixed to two opposing body panels of said remote-controlled toy airplane by screws to secure said two track boards to said two opposing body panels of said remote-controlled toy airplane.
